(19) United States
(12) Patent Application Publication
(10) Pub. No.: US 2016/0325455 A1
(43) Pub. Date: Nov. 10, 2016

(54) STRIPPING DEVICES AND PUNCH ASSEMBLIES

(71) Applicant: Dayton Lamina Corporation, Dayton, OH (US)

(72) Inventors: James F. Folker, Dayton, OH (US); Brian S. Marsh, Dayton, OH (US); William Paul Gillen, Dayton, OH (US)

(21) Appl. No.: 15/212,988

(22) Filed: Jul. 18, 2016

Related U.S. Application Data
(63) Continuation-in-part of application No. 15/000,266, filed on Jan. 19, 2016.
(60) Provisional application No. 62/105,036, filed on Jan. 19, 2015.

(51) Int. Cl. B26D 7/18; B26F 1/14

(52) U.S. Cl. CPC B26D 7/1836; B26F 1/14; B26D 2007/189

(57) ABSTRACT

A stripping device for stripping a workpiece from a punch includes a body having a sidewall that defines a bore. The bore includes a first portion and a second portion spaced at distances from an axis of the bore. The first portion is dimensioned such that the sidewall at least partially closes off one end of the body. A stripping element engages the first portion of the body and has a sidewall. A bore of the stripping element receives the punch during operation of the stripping device. A backup plug has a circular bore and is threadably secured in the bore of the body. The circular bore is sized to guide the punch into the bore of the stripping element during assembly of the stripping device onto the punch. A spring element is between the backup plug and the stripping element and includes a disc spring or a coil spring.

### CROSS REFERENCE

This application is a continuation-in-part application of U.S. application Ser. No. 15/000,266 filed Jan. 19, 2016, which claims priority to U.S. Provisional Patent Application Ser. No. 62/105,036 filed Jan. 19, 2015, the disclosures of which are incorporated by reference herein in their entireties.

### TECHNICAL FIELD

The present invention relates generally to punch assemblies and, more specifically, to stripping devices and punch assemblies for use during stamping processes.

### BACKGROUND

Stripping devices are known for use with various types of cutting tools. In particular, a stripping device may be used during stamping of a part. The part may be in the configuration of the metal sheet. The stripping device strips the metal sheet from the cutting element, such as a punch, during withdrawal of the punch from the sheet. During the perforating process, a front surface of a stripping element is placed against the metal sheet. When the punch is pulled out of the workpiece, the stripping element may push the metal sheet off of the punch during its withdrawal.

One problem encountered with current stripping devices is that the stripping device may rotate relative to the punch during operation. Relative rotation between the stripping element and the sheet can be a problem particularly where the part being punched has a specific orientation during machining, for example, as determined by its shape. Misalignment between the two may damage the part because the stripping element may locally deform the part in the area of misalignment leaving a visually perceptible blemish or other defect.

Another problem may be encountered during assembly of the stripping device onto the punch. Poor alignment between the punch and the stripping device may damage the stripping device or punch. Further, difficulties during installation result in greater than necessary down time and lost production.

While some strippers have been commercially successful, there exists a need for a stripper that improves assembly while limiting or eliminating relative rotation between the cutting element and the stripping device.

### SUMMARY

To address these and other drawbacks, a stripping device for stripping a workpiece from a punch includes a body having a sidewall that defines a bore. The bore includes a first portion and a second portion spaced at different distances from a longitudinal axis of the bore. The first portion is dimensioned such that the sidewall at least partially closes off one end of the body relative to the second portion. A stripping element slidably engages the first portion of the body and has a sidewall. A bore of the stripping element receives the punch during operation of the stripping device. A backup plug has a circular bore and is threadably secured in the bore of the body opposite the partially closed off end. The circular bore is sized to guide the punch into the bore of the stripping element during assembly of the stripping device onto the punch. The stripping device includes a spring element between the backup plug and the stripping element.

In one embodiment, the spring element includes a disc spring. The spring element may include a stack of at least two disc springs, which may be arranged in an alternating up-down configuration.

In one embodiment, the circular bore of the backup plug is at most 0.010 inch larger than an outside diameter of the punch.

In one embodiment, the circular bore of the backup plug is from 0.0005 inch to 0.010 inch larger than an outside diameter of the punch.

In one embodiment, the backup plug includes a recess that is configured to receive a tool to at least tighten the backup plug to the body.

In one embodiment, the backup plug includes a pair of recesses spaced apart on opposite sides of the circular bore. The recesses are configured to receive a spanner wrench.

In one embodiment, the sidewall of the stripping element has a non-circular cross section.

In one embodiment, the first portion of the bore has a non-circular profile that matches the shape of the non-circular cross section of the stripping element.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a partial cross-sectional elevation view of a punch assembly mounted for engagement with a workpiece according to one embodiment of the invention;

FIG. 2 is a perspective view of a punch assembly according to one embodiment of the invention;

FIG. 3A is a cross-sectional view of one embodiment taken along section line 3-3 in FIG. 2;

FIG. 3B is a cross-sectional view of one embodiment taken along section line 3-3 in FIG. 2;

FIG. 3C is an enlarged view of the encircled area 3C in FIG. 3A;

FIG. 4 is a top plan view of the punch assembly shown in FIG. 2;

FIG. 5 is a perspective view of a stripping member according to one embodiment of the invention;

FIG. 6 is a perspective view of a backup plug according to one embodiment of the invention;

FIG. 7 is a plan view of the backup plug shown in FIG. 6;

FIG. 8 is a disassembled cross-sectional view of one embodiment of the invention;

FIGS. 9A, 9B, and 9C are side elevation views of different configurations of the disc spring stacks shown in FIG. 8 according to embodiments of the invention; and

FIGS. 10A, 10B, and 100 are side elevation views of individual segments of the disc spring stacks shown in FIGS. 9A and 9B.

### DETAILED DESCRIPTION

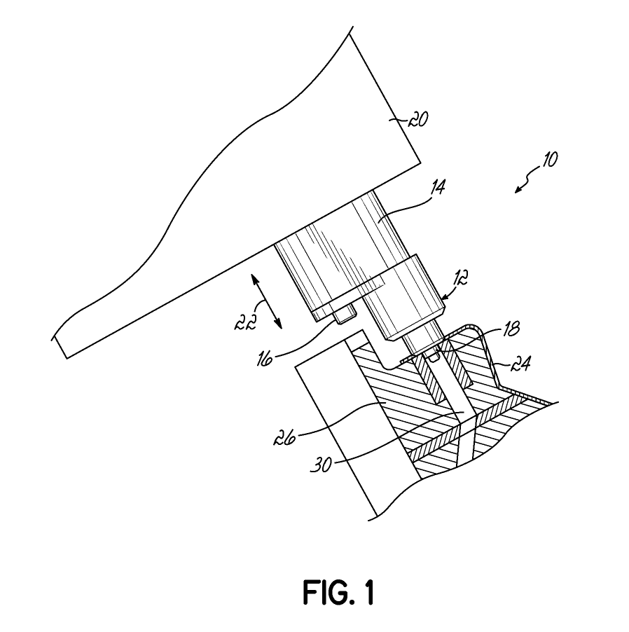

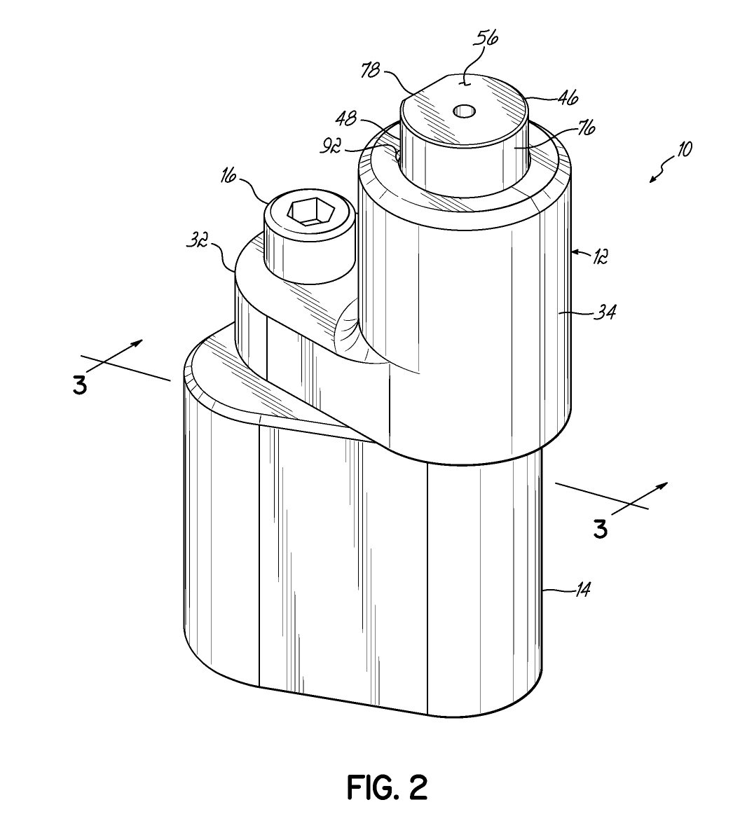

With reference to FIGS. 1 and 2, in an exemplary embodiment of the present invention, a punch assembly 10 includes a stripping device 12 secured to a punch retainer 14 with a screw 16. A punch 18 is coupled to the retainer 14 (FIG. 1). When mounted on a machine 20, reciprocating movement according to the arrow 22 forces impact between the punch assembly 10 and a workpiece 24. The punch assembly 10 is shown in contact with the workpiece 24 in FIG. 1. The workpiece 24 may be a piece of sheet metal and, as shown, the workpiece 24 may have curvature in one or more dimensions. That is, the workpiece 24 may not be flat. By the reciprocating movement, the punch 18 cuts a hole in the workpiece 24. By the same reciprocating movement, the stripping device 12 contacts the workpiece 24.

Upon withdrawal of the punch 18 from the workpiece 24, the stripping device 12 forces the workpiece 24 to detach from the punch 18. While not shown, it will be appreciated that relative movement between the machine 20 and the workpiece 24 positions the punch assembly 10 at a location that allows one workpiece to be removed and another workpiece to be positioned for machining. In the exemplary embodiment shown, the punch assembly 10 may also include a mating die 26 that receives the punched out section (not shown) of the workpiece 24 within a passage 30.

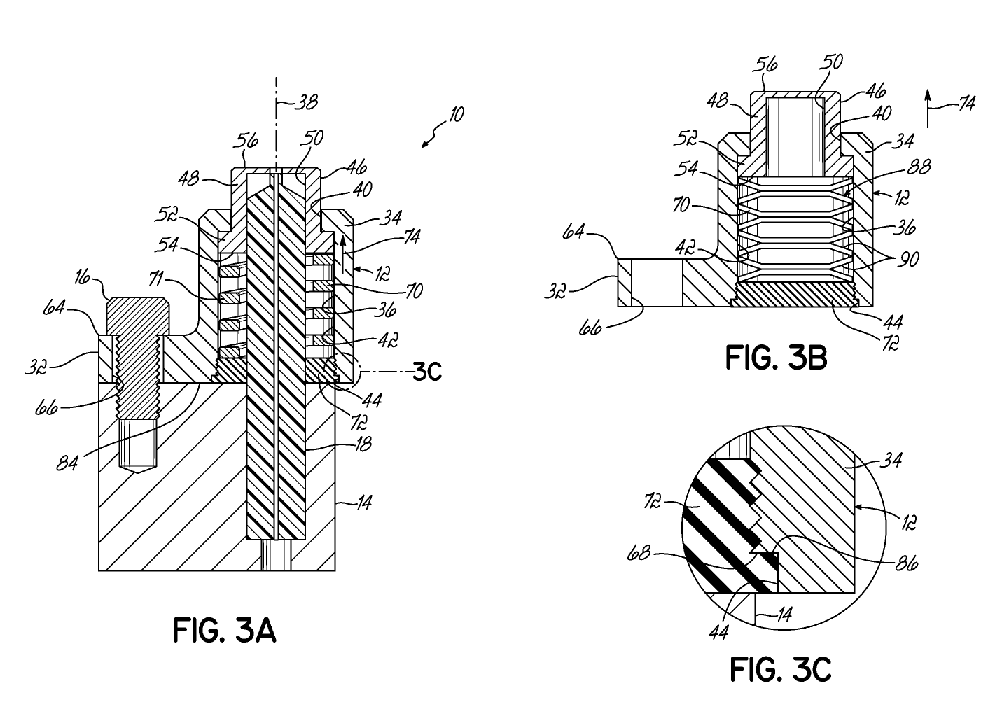

To that end, and with reference to FIGS. 2 and 3A, in one embodiment of the invention, the stripping device 12 includes a body 32 having a sidewall 34 that encloses a bore 36. The sidewall 34 may define multiple dimensions for the bore 36 from a longitudinal axis 38. For example, the sidewall 34 may define a first portion 40 of the bore 36 at a distance that is closest to the longitudinal axis 38, a second portion 42 of the bore 36, and a third portion 44 of the bore 36 at a distance that is the furthest from the longitudinal axis 38.

In one embodiment, as is shown best in FIG. 4, the first portion 40 has a non-circular profile so that the sidewall 34 may partially close off the bore 36 at one end of the body 32. The first portion 40 of the bore 36 is therefore positioned closer to the longitudinal axis 38 relative to one or both of the portions 42 and 44 of the bore 36. At the partially closed-off end, the sidewall 34 may extend toward the longitudinal axis 38 to define a circular portion 60 and a flat 62 in the bore 36. By way of example only, the circular portion 60 and the flat 62 may have a D-shaped profile along at least a portion of the bore 36. In one embodiment, the flat 62 may terminate at each end with a relief region, which is shown in the exemplary embodiment as a fillet 92. The fillets 92 may transition from the flat 62 to the circular portion 60 and may reduce or inhibit binding between the stripper 46 and the body 32 if the stripper 46 rotates slightly relative to the body 32 when the punch assembly 10 is in operation. As is described below, the first portion 40 of the bore 36 may operate to substantially prevent relative rotation of a portion of the stripping device 12 relative to the workpiece 24.

The body 32 may also include a flange 64 that extends generally laterally (e.g., perpendicularly) from the sidewall 34. The flange 64 may have a bore 66 formed therethrough that is configured to receive the screw 16 for attachment of the stripping device 12 to the retainer 14. As shown in FIG. 3A, the body 32 houses at least three other elements of the stripping device 12 within the bore 36.

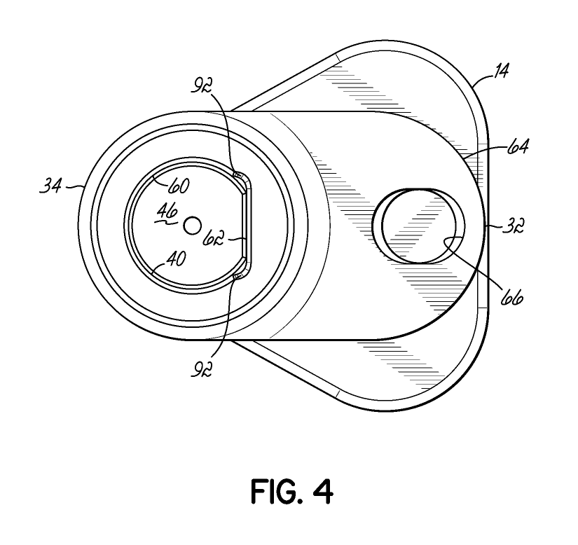

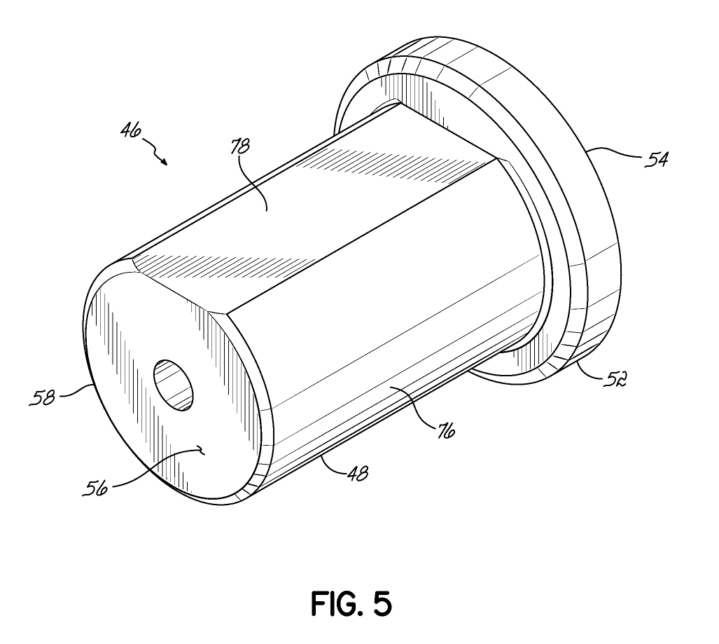

In one embodiment and with reference to FIGS. 3A and 5, the stripping device 12 includes a stripping member or stripper 46. The stripper 46 has a sidewall 48 that defines a bore 50. The punch 18 slides within the bore 50 during operation of the punch assembly 10 as depicted in FIG. 1. The sidewall 48 may include a generally perpendicular projection or head 52 that extends outwardly at one end 54 and a front surface 56 at an opposing end 58. As a result, the sidewall 48 may have a generally L-shaped cross-section (as is shown in FIG. 3A). The front surface 56 of the stripper 46 contacts the workpiece 24 as is shown in FIG. 1.

In one embodiment, the sidewall 48 has a non-circular configuration in which a first portion 76 has a generally right circular cylinder shape from the head 52 to the front surface 56 with a flat portion 78 extending the length of the circular cylinder. The first portion 76 and the flat portion 78 generally define a non-circular cross section, for example, a D-shaped cross section. In one embodiment, the non-circular cross section of the stripper 46 matches the non-circular profile of the first portion 40 of the bore 36. When assembled with the body 32, the first portion 76 and the flat portion 78 align in close proximity with the circular portion 60 and the flat 62 of the first portion 40 of the body 32. Once aligned, the stripper 46 may slide relative to the body 32 along the axis 38. However, the relationship and interaction between the flat 62 and the flat 78 may prevent rotation of the stripper 46 relative to the body 32 around the axis 38. As a result, it will be appreciated that the front surface 56 of the stripper 46 may stay in position relative to the punch 18 and so consistently contact the workpiece 24 in one orientation relative to the punch 18 during machining.

According to FIG. 3A, as described above, the stripper 46 is slidably received in the bore 36 along the axis 38. When positioned at the partially closed end of the body 32, the head 52 may contact the second portion 42 of the bore 36. In conjunction with that arrangement, the sidewall 48 may slide in contact with the first portion 40 in a motion substantially parallel to the axis 38. The body 32 houses another element that interacts with the stripper 46.

In one embodiment, the stripping device 12 includes a spring element 70 that resides within the bore 36, particularly within the second portion 42 of the bore 36. The spring element 70 cooperates with the end 54 of the stripper 46 and may bias the stripper 46 to extend from the body 32 as is shown in FIGS. 2 and 3. By way of example and not limitation, the spring element 70 may include a coil spring 71 (FIG. 3A) or a disc spring 90 (FIG. 3B), which may create higher pressure on the stripper 46 and may provide other advantages, described below. When the stripper 46 is biased in a fully extended position (shown in FIGS. 3A and 3B), the head 52 of the stripper 46 may abut the sidewall 34 proximate the first portion 40 of the bore 36. The sidewall 34 at the first portion 40 of the bore 36 may provide a fixed stop between the body 32 and the stripper 46.

With reference to one embodiment shown in FIG. 3B, the spring element 70 includes a stack 88 of disc springs 90. In the exemplary embodiment, there are eight disc springs 90 in the stack 88, though embodiments of the present invention are not limited to any specific number of disc springs in the stack 88. Advantageously, a stack 88 of disc springs 90 may reduce or eliminate torque on the stripper 46 during operation of the punch assembly 10. When other spring configurations are used, wear on the stripper 46 may be observed. Use of disc springs may reduce or eliminate wear on the stripper 46. Without being bound by theory, wear on the stripper 46 is believed to be caused by an internal torque on the stripper 46. Torque may initially result in slight relative rotation between the stripper 46 and the body 32, particularly between the flat portion 78 and the flat 62. After prolonged use of the punch assembly 10, the slight rotation under repeated torque loading may wear the stripper 46. Wear on the stripper 46 may be significant when the stripper is made of bronze. Ultimately, wear on the stripper 46, particularly at the flat portion 78, is likely to allow significant unintended rotation between the stripper 46 and the body 32 during use of the punch assembly 10. Any benefit associated with the preferred alignment between the stripper 46 and the body 32 as provided by the alignment of the flat portion 78 and the flat 62 would be lost.

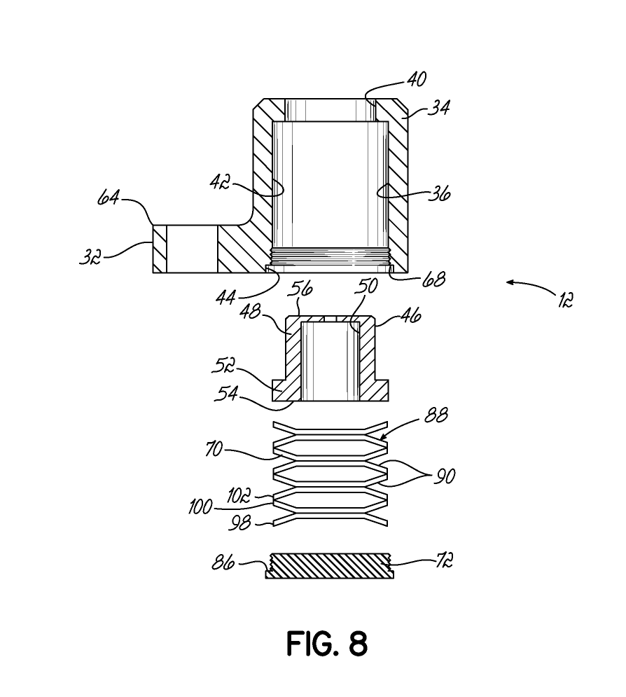

With reference to FIGS. 3A, 3B, 3C, 6, and 8, the body 32 also receives a backup plug 72. In this regard, the second portion 42 or the third portion 44 of the bore 36 may be threaded. The backup plug 72, which may also be threaded, may be assembled into the threaded portion of the bore 36. The third portion 44 may be a larger dimension (e.g., larger in diameter) than the dimension of the second portion 42 of the bore 36. This difference in dimension results in an offset 68 (shown best in FIG. 8) between the second portion 42 and at least a portion the third portion 44 of the bore 36. The backup plug 72 may be threaded into the bore 36 to a predetermined depth defined by the offset 68. When inserted into the bore 36, the backup plug 72 may define a planar surface 84 with the flange 64, as is shown best in FIGS. 3A, 3B, and 3C. The surface 84 may then abut the retainer 14 when the stripping device 12 is secured to the retainer 14.

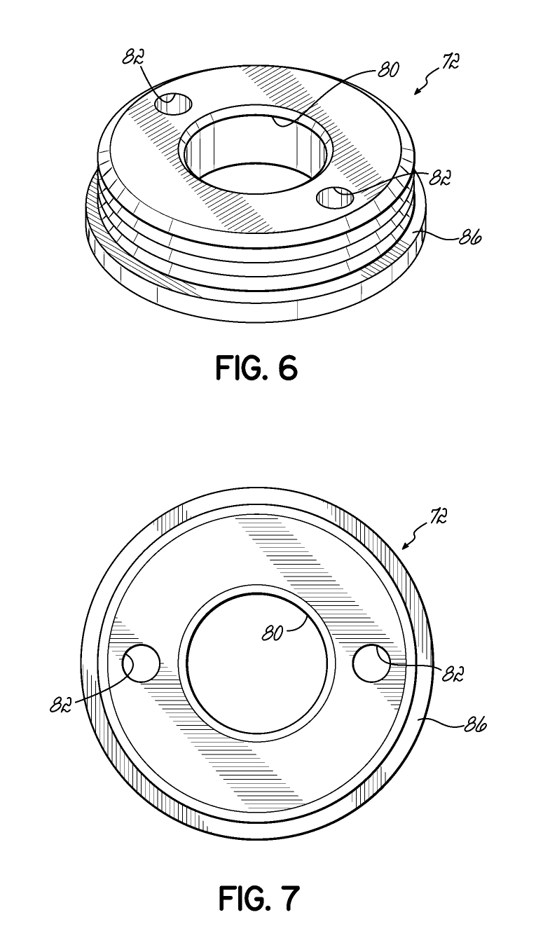

As shown best in FIGS. 6 and 7, in one embodiment, the backup plug 72 includes a shoulder 86 that is received in the third portion 44 of the body 32. The offset 68 between the second portion 42 and the third portion 44 may limit the depth to which the backup plug 72 may be installed into the bore 36 when the shoulder 86 bottoms out at the offset 68.

In one embodiment, the overall height dimension of the spring element 70 may be greater than the dimension between the backup plug 72 and the stripper 46 when the stripping device 12 is assembled. Accordingly, threading the backup plug 72 into the body 32 may compress the spring element 70 by a predetermined amount. Compression of the spring element 70 biases the stripper 46 in the direction of the arrows 74 in FIGS. 3A and 3B with a predetermined load. It will be appreciated that when the spring element 70 is compressed by a predetermined amount and the stripper 46 contacts the workpiece 24, the spring element 70 initially applies the load to the workpiece 24 before the head 52 of the stripper 46 separates from the sidewall 34. After application of a load sufficient to separate the head 52 from the sidewall 34, the spring element 70 is compressed during reciprocation of the punch 18 through the workpiece 24.

With reference to FIGS. 6 and 7, the backup plug 72 has a generally toroidal configuration with a bore 80 that receives the punch 18 (shown in FIG. 3). The bore 80 is circular with a continuous perimeter. The continuous perimeter lacks any flats or other sharp discontinuities, such as, edges designed to cooperate with a tool to tighten or loosen the backup plug 72. The circular perimeter is defined by a diameter that measures slightly larger (e.g., at most 0.010 inch) than the outside dimension of the punch 18. For example, the diameter of the circular bore 80 may measure from 0.0005 in to 0.010 inch and, by way of further example, may measure from 0.004 inch to 0.010 inch larger than the outside diameter of the punch 18. It will be appreciated that the circular bore 80 of the exemplary oversized diameter may guide insertion of the punch 18 through the punch assembly 10 when the stripping device 12 is assembled with the retainer 14. However, the bore 80 does not interfere with sliding movement of the punch 18 through the backup plug 72 during machining.

In one embodiment, the backup plug 72 may also include spaced apart recesses 82. The recesses 82 may be in the configuration of through bores. Although not shown, the recesses 82 may alternatively be configured as blind bores. The recesses 82 receive a tool, such as, a spanner wrench, for tightening and loosening the backup plug 72 within the third portion 44 of the bore 36 during assembly and disassembly of the stripping device 12.

With reference now to FIG. 8, in one embodiment, the stack 88 includes a plurality of individual, separate disc springs 90. Although not shown, it will be appreciated that each disc spring 90 may have a frusto-conical shape and may include a through bore so that the disc spring 90 may have a conical washer-like configuration. Disc springs capable of being utilized in accordance with embodiments of the present invention include those commercially available from Mubea of Florence, Kentucky. The disc springs 90 may be stacked in a variety of configurations in the body 32.

In one embodiment, the individual disc springs 90 may be stacked in an alternating up-down configuration. That is, with reference to FIGS. 8, 9A, and 10A, one disc spring 98 may be positioned so as to have a conical portion 104 facing toward the stripper 46 and the adjacent disc spring 100 may have the opposite orientation. The disc springs 98 and 100 may not be secured to one another. In that regard, the springs 98 and 100 may be loosely held in their relative orientations when assembled in the body 32. With these relative orientations, the conical portions 104 of the adjacent disc springs 98, 100 are in contact with one another. The next disc spring 102 in the stack 88 may begin repetition of the relative orientation of springs 98, 100. In that regard, the disc spring 102 may be positioned so that an edge portion 106 is in contact with an edge portion 106 of the disc spring 100. In this way, the stack 88 includes alternating conical portion contact and edge portion contact between adjacent disc springs 90. Embodiments of the invention may include other stack configurations to increase the spring force and/or to increase the available travel of the stripper 46 relative to the body 32.

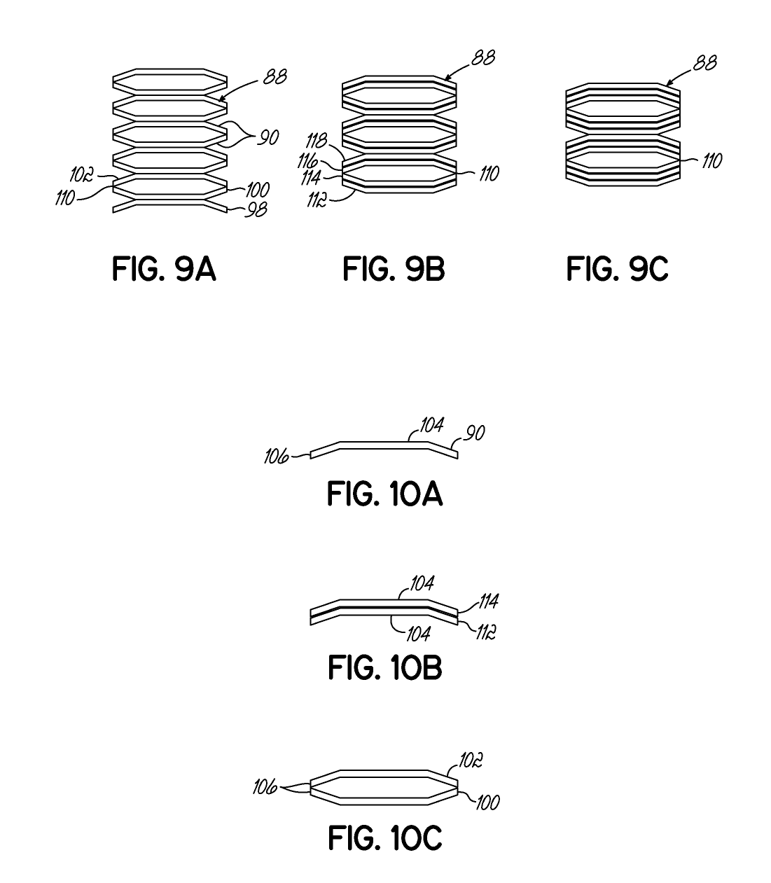

In particular, and with reference to FIGS. 9A, 9B, and 9C, by way of example only and not limitation, a variety of stacks 88 are shown. In FIGS. 9A, 9B, and 9C, a layer 110 of disc springs 90 may be formed by a plurality of disc springs that are aligned and stacked in conforming fashion. A single-stack layer 110 having two disc springs 90 is shown in FIG. 9A. Two springs 90 are oriented in an edge-to-edge configuration between disc spring 100 and disc spring 102. The conical portions of the disc springs 100 and 102 are spaced apart from one another. The springs 90 in one or more layers 110 in FIGS. 9B and 10B may be double stacked or triple stacked, respectively.

In FIG. 9B, in the double stacked layer 110, there are four disc springs total. Two disc springs 112 and 114 may be stacked together so as to align their conical portions 104 and the edge portions 106 in contact with one another, and two disc springs 116 and 118 may also be stacked together so as to align their conical portions 104 and the edge portions 106 in contact with one another. The edge portions 106 of the springs 114 and 116 are in contact with one another.

With reference to FIG. 9C, one or more layers 110 may include more than four disc springs. For example, at least one of the layers 110 in the stack 88 may be triple stacked or include six disc springs. Three disc springs may have one orientation and another three may have the reverse orientation. The two middle disc springs are arranged edge-to-edge. It will be appreciated that each layer 110 does not necessarily require the same number of disc springs. For example, one layer may be triple stacked with an adjacent layer being single or double stacked. Furthermore, one or more of the layers 110 may include an odd number of disc springs 90, such as three, five, or more disc springs. The disc springs 90 may be oriented and stacked in layers sufficient to fill available space within the body 32.

With reference to FIGS. 10A-10C, the force and travel of the stack 88 may depend on how each spring in the stack 88 is oriented relative to the remaining springs in the stack 88. By changing the orientation of one or more of the individual springs 90 in the stack 88, it is possible to alter the force that the stack 88 exerts on the stripper 46. It is also possible to preset how far the stack 88 may be compressed during use of the punch assembly 10. For example and with reference to FIG. 10A, a single spring 90 may produce a predetermined force (1F) and allow a predetermined distance of travel (1T).

In FIG. 10B, the two disc springs 112 and 114 produce twice the predetermined force (i.e., 2F) of the single spring 90 shown in FIG. 10A and have a similar predetermined distance of travel (i.e., 1T). With reference to FIG. 100, the two disc springs 100 and 102 produce about the same force (i.e., 1F) but allow twice the travel (i.e., 2T) of the single spring 90 shown in FIG. 10A. In view of the above, according to embodiments of the invention, the stack 88 of disc springs 90 may be configured to produce a known force and allow the stripper 46 to travel a known distance. By rearrangement of the springs within the stack 88, an operator of the punch assembly 10 may easily alter one or both of the force and distance of travel. In view of the above, the disc springs 90 may oriented to so as to produce multiple forces and ranges of travel for any given application of the punch assembly 10.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. A stripping device for stripping a workpiece from a punch, the stripping device comprising:
a body having a sidewall defining a bore along a longitudinal axis, the bore having a first portion and a second portion spaced at different distances from the longitudinal axis, the first portion being dimensioned such that the sidewall at least partially closes off one end of the body relative to the second portion;
a stripping element having a sidewall defining a bore and being slidably engaged with the first portion of the bore of the body along the longitudinal axis, the bore receiving the punch during operation of the stripping device;
a backup plug having a circular bore and being threadably secured in the bore opposite the partially closed off end of the body, the circular bore being sized to guide the punch into the bore of the stripping element during assembly of the stripping device onto the punch; and
a spring element between the backup plug and the stripping element.

2. The stripping device of claim 1, wherein the spring element includes a disc spring.

3. The stripping device of claim 1, wherein the spring element includes a stack of at least two disc springs.

4. The stripping device of claim 3, wherein the at least two disc springs are arranged in an alternating up-down configuration.

5. The stripping device of claim 3, wherein each disc spring includes an edge portion and a conical portion and the at least two disc springs are arranged in an edge-to-edge configuration with the conical portion of the at least two disc springs being spaced apart from one another.

6. The stripping device of claim 3, wherein each disc spring includes an edge portion and a conical portion and the at least two disc springs are arranged with the edge portions and the conical portions in contact with one another.

7. The stripping device of claim 3, wherein the stack includes at least four disc springs.

8. The stripping device of claim 1, wherein the circular bore of the backup plug is at most 0.010 inch larger than an outside diameter of the punch.

9. The stripping device of claim 1, wherein the circular bore of the backup plug is from 0.0005 inch to 0.010 inch larger than an outside diameter of the punch.

10. The stripping device of claim 1, wherein the backup plug includes a recess that is configured to receive a tool to at least tighten the backup plug to the body.

11. The stripping device of claim 1, wherein the backup plug includes a pair of recesses spaced apart on opposite sides of the circular bore, the recesses being configured to receive a spanner wrench.

12. The stripping device of claim 1, wherein the sidewall of the stripping element has a non-circular cross section.

13. The stripping device of claim 12, wherein the first portion of the bore has a non-circular profile that matches the shape of the non-circular cross section of the stripping element.
